(19) United States
(12) Patent Application Publication
(10) Pub. No.: US 2025/0170582 A1
(43) Pub. Date: May 29, 2025

(54) CRUSHER SCREENING UNIT

(71) Applicant: Portafill International Limited, Dungannon (GB)

(72) Inventor: Malachy James RAFFERTY, Omagh (GB)

(73) Assignee: Portafill International Limited, Dungannon (GB)

(21) Appl. No.: 18/956,531

(22) Filed: Nov. 22, 2024

(30) Foreign Application Priority Data
Nov. 29, 2023 (GB) 2318236.3

(51) Int. Cl. B02C 23/08; B02C 23/02

(52) U.S. Cl. CPC B02C 23/08; B02C 23/02

(57) ABSTRACT

The present invention discloses a crusher screening unit for use between a crusher material feeder and a material crushing zone, the unit comprising a first grid of elongate fixed longitudinal bars, and a second grid of elongate moveable longitudinal bars interspaced with the fixed longitudinal bars, wherein the second grid is directly driven in use in an eccentric motion relative to the first grid.

### CROSS REFERENCE TO RELATED APPLICATIONS

This application claims priority benefit from Great Britain Application No. 2318236.3 filed on Nov. 29, 2023, entitled “Crusher Screening Unit”, which is incorporated herein by reference in its entirety.

### FIELD OF THE INVENTION

The present invention relates to a crusher screening unit for use between a crusher material feeder and a material crushing zone, and a method of same.

### BACKGROUND TO THE INVENTION

Crushers are able to reduce various materials such as concrete, asphalt, rock, rubble and stone, into smaller sized materials. The smaller sized materials may be reusable, and therefore a valuable commodity product in their own right.

A crusher generally comprises a feed material, which is generally provided by or along a feeder or feed hopper or feed conveyor into a crushing zone, being an area having a rotor with hammers or bars. The feed material is rotated by the bars against a main impact wall or plate, until it is reduced in size to pass out of the crushing zone, and towards a suitable collection place, generally at the bottom of the crushing zone. Typically, the collection place is or has one end of an outlet conveyor, able to convey the outlet material in its reduced size to a suitable store, location or to waiting transportation.

Prior to the crushing zone, it can be desired to pre-screen the feed material, to remove ‘undersized’ material that does not need crushed, or is not part of the desired outlet material.

Various pre-screeners are known in the art. Known units are usually heavy-duty screens, which require two separately drivable machines that have a large overall height and length, which also has disadvantages for the transport of such devices in particular. Heavy-duty screens are usually designed as mechanically, electrically, hydraulically or the like driven vibrating screens, with which a clean separation of coarse grain and smaller grain sizes can be achieved, but which are costly to manufacture, require a large amount of space and must always be supplied with power, which is why they incur high maintenance costs.

DE3834381A describes a separation of coarse grain from smaller grain fractions is carried out by means of a sieve consisting of sieve bars arranged side by side at a distance from each other and descending in the conveying direction of the coarse grain. In the known sieve, two rows of sieve bars are arranged one above the other, but offset from each other. EP3090817 describes a device for separating coarse grain and smaller grain sizes with a sieve section consisting of vibration-excitable sieve rods arranged side by side, with one group of rods being fixed, and another set of rods being passively vibrated.

The present invention relates to an improvement to a crusher screening unit.

### SUMMMARY OF THE INVENTION

According to one aspect of the present invention, there is provided a crusher screening unit for use between a crusher material feeder and a material crushing zone, the unit comprising a first grid of elongate fixed longitudinal bars, and a second grid of elongate moveable longitudinal bars interspaced with the fixed longitudinal bars, a, wherein the second grid is directly driven in use in an eccentric motion relative to the first grid.

According to another aspect of the present invention, there is provided a crusher comprising a crusher screening unit as defined herein, optionally mounted on a mobile chassis.

According to a further aspect of the present invention, there is provided a method of screening crushing material prior to crushing, comprising the steps of:
(a) providing material to crusher screening unit as defined herein;
(b) directly driving the second grid in an eccentric motion relative to the first grid; and
(c) providing a screen material for subsequent crushing.

According to a further aspect of the present invention, there is provided a screening unit for screening aggregate material, the unit comprising a first grid of elongate fixed longitudinal bars, and a second grid of elongate moveable longitudinal bars interspaced with the fixed longitudinal bars, wherein the second grid is directly driven in use in an eccentric motion relative to the first grid.

According to another aspect of the present invention, there is provided an aggregate processing plant for screening aggregate material comprising a mobile chassis having a main frame and a vibrating screening unit mounted via one or more absorbers on a screen-mounting frame, and able to provide at least one aggregate discharge stream therethrough, wherein the feed for the vibrating screening unit includes a screening unit as defined herein.

### BRIEF DESCRIPTION OF THE DRAWINGS

Embodiments of the present invention will now be described by way of example only and with reference to the accompanying drawings, in which:

FIG. 1 is a part-open view of an impact crusher assembly according to an embodiment of the present invention;

FIGS. 2a and 2b are perspective and side views respectively of the hopper feeder unit of FIG. 1, including a screening unit, in accordance with an aspect of the present disclosure;

FIGS. 3a and 3d are perspective and reverse perspective views respectively of the screening unit of FIGS. 2a and 2b, and according to a second embodiment of the present inventiont, in accordance with an aspect of the present disclosure;

FIGS. 3b and 3c are split perspective views of a first grid of elongate fixed longitudinal bars, and a second grid of elongate moveable longitudinal bars interspaceable with the first grid, respectively, of the screening unit shown in FIGS. 3a and 3dt, in accordance with an aspect of the present disclosure;

FIG. 4 is a schematic side view of the screening unit of FIGS. 3a-3dt, in accordance with an aspect of the present disclosure;

FIG. 5a is a schematic view of a direction of the eccentric driveshaft of FIG. 4t, in accordance with an aspect of the present disclosure; and

FIGS. 5b-5e are four schematic views of portion A of FIG. 4 at different positions of the eccentric driveshaft of FIG. 5at, in accordance with an aspect of the present disclosure.

### DETAILED DESCRIPTION FOR CARRYING OUT THE INVENTION

The present invention relates to a crusher screening unit for use in a crusher able to reduce various materials such as concrete, asphalt, rock, rubble and stone, into smaller sized materials. The smaller sized materials may be reusable, and therefore a valuable commodity product in their own right.

Various crushers and crushing plants are known in the art, and include impact crushers, jaw crushers, roll crushers, and the like. Such crushers and plants can be used in quarrying, recycling and demolition applications.

For example, impact crushers use impact and striking as a way to reduce the size of the material in their main processing stage. The impact crusher assembly is able to utilise the high speed impact energy of the rotor core to breakdown the material into suitable or workable particle sizes. An impact crusher assembly typically has a rotor core and a plurality of blow bars mounted thereon in a manner known in the art. Typically, the number of bars is 2, 3, 4 or more, typically 4, and symmetrically arranged around the rotor core to extend radially therefrom. The bars are typically formed of a hard or hardwearing material, typically cast steel which can be replaced over time. The bars are designed to with stand many impacts on material at the high rotation speeds of the rotor core.

The feeder for the material into the crushing area or zone of the crusher may comprise one or more of the group comprising a hopper, a feed conveyor, a slide or a chute. Typically, the feeder has an open top and slide plates, typically inclined slide plates, to create a pathway for feed material onto a conveyor belt, which conveyor belt can provide the feed material from a feed area or end towards the rotor core and bars. The area around the rotor core and bars can be defined as a ‘crushing zone’ or ‘crushing box’ or similar.

The present invention comprises a crusher screening unit to act as a pre-screener between the feeder and the crushing zone. The screening unit is able to screen some of the feed material, to pre-remove material not desired or required to be crushed by the subsequent crushing action of the rotor core, etc. Typical material removed by a screening unit can be dirt, or loose material, or ‘fines’. Such material can pass by gravity, and/or by positive action of the screening unit, towards a suitable collection location of area, such as a suitable collection tray, or an inlet end of a suitable conveyor able to convey such material away from the crusher assembly.

Various pre-screeners are known in the art. Heavy-duty screens are usually designed as mechanically, electrically, hydraulically or the like, driven vibrating screens, but they incur high maintenance costs, being heavy duty. Such maintenance costs include downtime to clear out material that regularly gets stuck between the bars or rods or wires of the pre-screener and clogs up the pre-screener. To reduce this, EP3090817 describes a device consisting of vibration-excitable sieve rods arranged side by side, with one group of rods being relatively fixed, and another set of rods being passively vibrated via spring dampers. However, such a device still regularly gets material stuck between its rods to clog up the rods, and so still requires to be regularly stopped and cleared out.

The crusher screening unit of the present invention comprises a crusher screening unit for use between a crusher material feeder and a material crushing zone, the unit comprising a first grid of elongate fixed longitudinal bars, and a second grid of elongate moveable longitudinal bars interspaced with the fixed longitudinal bars, a, wherein the second grid is directly driven in use in an eccentric motion relative to the first grid.

In this way, the direct driving of the second grid actively serves to keep the material being screened ‘moving along’ or across the screening area, and the eccentric driven motion of the second grid of bars relative to the first grid of bars actively forces the differential or out of phase or multi-mode motion thereinbetween, to maximise the prevention of clogging and pegging between the bars of the first and second grids. This positive driving force especially helps in relation to heavy-duty screens, which are typically being vibrated as well, to maximise the screening function of heavy materials, such as rubble and building wastes from demolition sites, etc., as mentioned above. The specific action of a crusher (to reduce various materials such as concrete, asphalt, rock, rubble and stone, into smaller sized materials), means that the crusher is already undergoing heavy and destructive actions alongside the pre-screening of the feed material.

Optionally, the upper portions of the fixed longitudinal bars and the upper portions of the moveable longitudinal bars are wholly or substantial the same in cross-section. That is, the upper portions of the fixed longitudinal bars and the upper portions of the moveable longitudinal bars, either when the unit is at rest or in a at least one position of the second grid relative to the first grid, have the same cross-sectional shape.

Optionally, the upper portions of the fixed longitudinal bars and the upper portions of the moveable longitudinal bars are T-shaped in cross-section.

Optionally, the upper portions of the fixed longitudinal bars and the upper portions of the moveable longitudinal bars are one or more of the following:
wholly or substantially parallel;
wholly or substantially co-planar;
wholly or substantially aligned;
wholly or substantially flat;
wholly or substantially similar in transverse cross-section.

Optionally, the upper portions of the fixed longitudinal bars and the upper portions of the moveable longitudinal bars form one or more than one levels along the length of the screening unit. Where the upper portions of the fixed longitudinal bars and the upper portions of the moveable longitudinal bars have one level, the top of the screening unit can be considered as wholly or substantially flat. Where the upper portions of the fixed longitudinal bars and the upper portions of the moveable longitudinal bars have more than one level or tier, they can form a number or series of steps along the length of the screening unit, such that there is a drop in height of the material being screened along the length of the screening unit.

Optionally, the upper portions of the fixed longitudinal bars and the upper portions of the moveable longitudinal bars are wholly or substantial Z or S shaped in a longitudinal direction, i.e. along the length of the screening unit, to provide a first upper level of screening, and a second lower level of screening, of the material being screened. That is, wherein the fixed longitudinal bars and the moveable longitudinal bars form a multiple-tiered screening surface.

Optionally, the elongate moveable longitudinal bars are securely attached to the first grid via a flexible joint or transverse plate. The flexible joint of transverse plate may be located below the fixed and moveable longitudinal bars. The flexible joint or transverse plate may be of any suitable flexible unit or material, able to accept the eccentric motion of the other ends of the moveable longitudinal bars, and accommodate such motion relative to the fixed nature of the first grid. The transverse plate made be made from any suitable material or combination of materials, including metal, hard rubber, hard plastic, etc.

Optionally, a flexible joint is one or more of a linkage, biaser, spring or cross-member, or multuiples thereof, able to ensure movement between the first and second grids, and to support the second grid relative to the first grid.

Optionally, a transverse plate is located below one end of the fixed and moveable longitudinal bars. In this way, the transverse plate is discretely positioned relative to the material being screen and for crushing.

Optionally, the transverse plate is fixed to a cross-plate supporting the fixed longitudinal bars, and fixed to a cross-plate supporting the moveable longitudinal bars.

Optionally, the moveable grid further comprises a supporting framework extending beneath the fixed and moveable longitudinal bars. The framework may have any suitable shape and design, which allows the first grid to be positioned in a complementary manner. The framework have a have a series of slots or gaps, through which the bars of the first grid can be located in use.

Optionally, the moveable grid further comprises a transverse cross-strut beneath the fixed and moveable longitudinal bars. A cross-strut can assist rigidity and consistency of motion between all the bars of the second grid.

Optionally, the upper portions of the moveable longitudinal bars longitudinally taper, optionally in the direction from a material feeder and towards a material crushing zone.

Optionally, the upper portions of the fixed longitudinal bars longitudinally taper, optionally in the direction from a material feeder and towards a material crushing zone.

Optionally, the upper portions of the moveable longitudinal bars and the fixed longitudinal bars longitudinally taper in a complementary fashion, optionally by the same degree or amount from a material feeder and towards a material crushing zone.

Optionally, the second grid is driven by a drive motor. Such drive motor may be a dedicated drive motor. Such motor may be supported by a frame, optionally a frame supporting the first grid.

Optionally, the second grid is driven by an eccentric shaft of the drive motor in any eccentric, i.e. non-circular manner, such as elliptical. The eccentric drive may have any suitable shape, typically a non-circular cross-sectional shape such as elliptical, or a shaft having one or more shapes around its circumference, in order to create an eccentric motion for the second grid.

The present invention is useable with any type of crusher, including but not limited to cone crushers, jaw crushers, roll crushers, gyratory crushers, and impact crushers. Thus, the present invention extends to a crusher comprising a crusher screening unit as defined herein.

In one embodiment of the present invention, the present invention extends to an impact crusher comprising a crusher screening unit as defined herein, optionally mounted on a mobile chassis. Such an impact crusher may include an impact crusher assembly comprising a plurality of blow bars mounted on a rotor core able to rotate about an axis, a feeder for material to the blow bars, and a primary impact plate co-operating with the blow bars and located radially outwardly from the blow bars. Optionally, the impact crusher includes a secondary impact plate located below the primary impact plate, more optionally, wherein the secondary impact plate is translationally moveable relative to rotor core.

Optionally, the crusher of the present invention may include a top gravity feeder or hopper able to feed material to the crusher screening unit. Feeder material can then pass by gravity, and/or by positive action of the pre-screener, towards a suitable collection location of area, such as a suitable collection tray, or an inlet end of a suitable conveyor able to convey such material away from the crusher assembly.

Optionally, the hopper is vibrated in use, to assist movement of material therealong towards the fee outlet. Optionally, the hopper and the crusher screening unit are integral, or at least support together, such that any general vibration of the hopper also causes vibration, or a vibrational movement, of the crusher screening unit.

The present invention also includes a method of screening crushing material prior to crushing, comprising the steps of:
(a) providing material to a crusher screening unit as defined herein;
(b) driving the second grid in an eccentric motion relative to the first grid; and
(c) providing a screen material for subsequent crushing.

The method includes providing material to the feeder by any suitable provider, including conveyors and loaders.

The screening unit of the present invention can act as a pre-screener between the feeder and the crushing zone of a crusher. The pre-screener is able to screen some of the feed material through one or more suitable sized screens, meshes, grids or similar, each typically having a pre-determined aperture size, to pre-remove material not desired or required to be crushed by the subsequent crushing action of the rotor core, etc. Typical material removed by a pre-screener can be dirt, or loose material, or ‘fines’. Such material can pass by gravity, and/or by positive action of the pre-screener, towards a suitable collection location of area, such as a suitable collection tray, or an inlet end of a suitable conveyor able to convey such material away from the crusher assembly.

The screening unit of the present invention can also act as a screening unit for screening aggregate material. Such a unit still comprises a first grid of elongate fixed longitudinal bars, and a second grid of elongate moveable longitudinal bars interspaced with the fixed longitudinal bars, wherein the second grid is directly driven in use in an eccentric motion relative to the first grid.

Thus, the present invention also provides an aggregate processing plant for screening aggregate material comprising a mobile chassis having a main frame and a vibrating screening unit mounted via one or more absorbers on a screen-mounting frame, and able to provide at least one aggregate discharge stream therethrough, wherein the feed for the vibrating screening unit includes a screening unit as defined herein.

Mobile aggregate processing plants for screening aggregate material are well known in the art: see for example U.S. Pat. No. 669,859B2. They generally comprise a vibrating screening unit, sometimes termed a ‘screen box’, having a series of heavy-duty screens with defined openings, such that an aggregate feed material can be separated by the moving screens into different sized discharge streams. Typically, there are one or more discharge streams at or near the end of the vibrating screening device of different particle sizes or coarseness, whilst that part of the aggregate material with a dimension less than the openings in the screens, is drawn by gravity down through the screen openings, and can be collected directly beneath the screening unit.

The discharge streams can be directed away from the plant by various suitable conveyors, generally being positioned in different directions, into suitable piles or into suitable containers or trucks, etc. Once feed material at one location is screened, the mobile aggregate processing plant can be relocated for processing a new feed of aggregate material, typically at or near the same site. The screens may be arranged in a series of levels, sometimes termed ‘decks’, such as ‘upper deck’ and ‘lower deck’.

The screening unit of the present invention can assist prevent clogging of feed material to the vibrating screen box. The mounting of the vibrating screen unit on the mobile aggregate processing plant may be at any suitable location, typically between a feed hopper and one or more discharge conveyors, with the screening unit between the hopper and the vibrating screening unit.

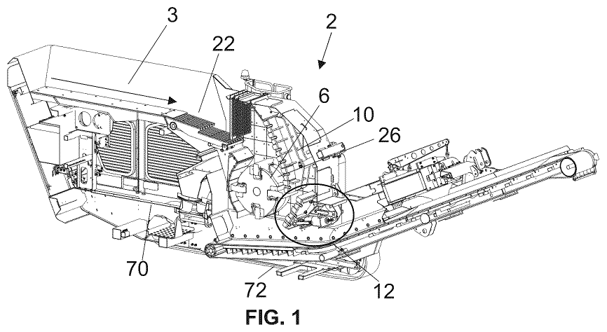

Referring to the drawings, FIG. 1 shows an impact crusher assembly 2 in an impact crusher. The impact crusher comprises a feeder hopper unit 3, a plurality of blow bars mounted on a rotor core 6 and able to rotate about an axis, a primary impact plate 10 co-operating with the blow bars, and a secondary impact plate 12 located below the primary impact plate 10. The impact crusher and impact crusher assembly 2 are mounted on a chassis 70, having a tracked wheel arrangement 72 to be mobile.

The feeder hopper unit 3 includes a screening unit 22 between a hopper and a crushing zone between the rotor 6 and the primary impact plate 10. Crushed or processed material passes outwardly along one or more suitable conveyors in a manner known in the art.

The skilled reader can see that the screening unit 22 can be used in another aggregate processing apparatus, particularly but not exclusively between a hopper or other aggregate feed input, and an aggregate processing apparatus, assembly or unit.

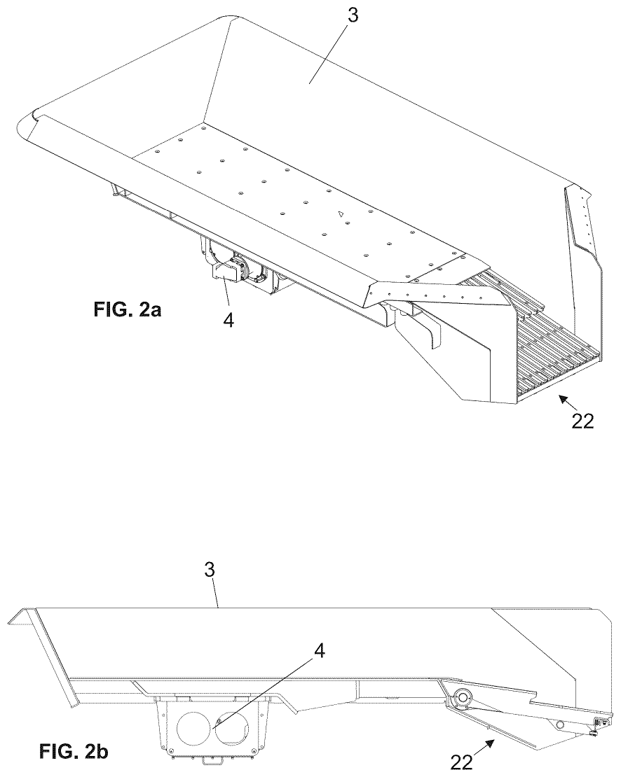

FIGS. 2a and 2b show in detail just the feeder hopper unit 3 in FIG. 1 with the screening unit 22 at one end thereof. The hopper unit 3 is, as a whole, vibrating in use, because of a hopper drive motor 4. The hopper drive motor 4 acts in a manner known in the art to cause vibration and assist movement of material in the feeder hopper unit 3 towards the crushing zone of the impact crusher assembly 2. As such, the screening unit 22 is also vibrating.

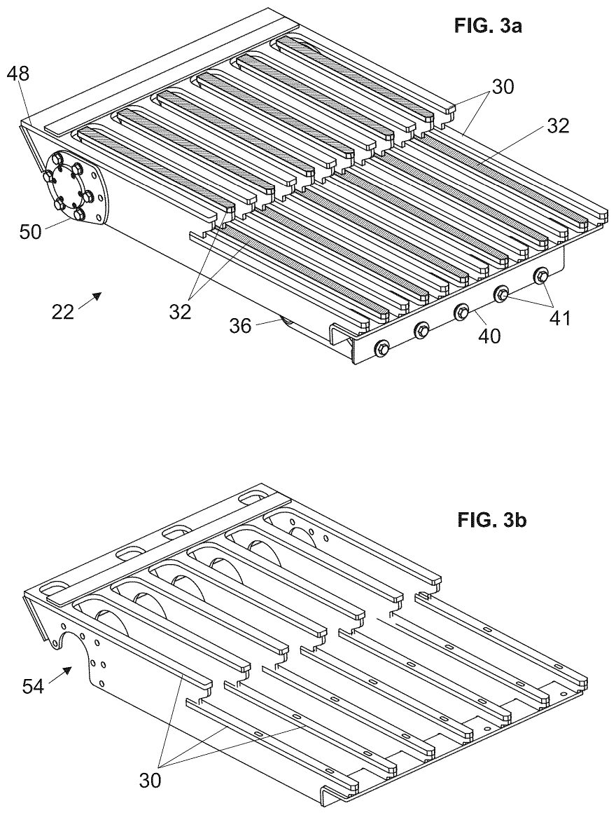

FIGS. 3a and 3d show the screening unit in more detail, and separate to the remainder of the feeder hopper unit 3 for clarity. The screening unit 22 comprises a first grid 30 of elongate fixed longitudinal bars, and a second grid 32 of elongate moveable longitudinal bars interspaced with the fixed longitudinal bars of the first grid 30. The first grid 30 and second grid 32 have their longitudinal bars arranged as having a step therealong, to create an upper or first top tier, and a second or lower tier, in the direction of feed material travelling thereacross. The skilled person can see that there can be other arrangements and relationships of the longitudinal bars of each grid to achieve screening of material between the feeder hopper unit 3 and the impact crushing assembly 2. For example, the longitudinal bars may be of a single tier, or more than two tiers, and may comprise other interleaving relationships.

FIG. 3b shows the first grid 30 separate from the second grid 32 and the remaining parts of the screening unit 22. FIG. 3c shows the second grid 32 separate from the first grid 30 and the remaining parts of the screening unit 22. FIG. 3b shows the first grid 30 having suitable cut-outs 54 to accommodate a shaft housing 56 of the second grid 32

In FIGS. 3a and 3d, one end 28 of the second grid 32 is securely attached to the first grid 30 via a flexible joint 40, and the other end 42 of the second grid 32 is driven in use in an eccentric motion relative to the first grid 30 as described in more detail hereinafter. The flexible joint 40 may be a transverse plate 40 or the like, securely fixed to the first grid 30 through a series of fixing means such as bolts, and securely fixed at separate locations to the second grid 32 through a series of fixing means such as bolts 41. However, the present invention is not limited by the location or fixing means shown in the FIGS. Other flexible joints can be located at other positions between the first and second grids 30, 32, to allow flexible movement thereinbetween to effect the present invention.

FIGS. 3a, 3c and 3d also show a transverse bar 36 connecting the elongate moveable longitudinal bars of the second grid 32 together, to assist their integral nature, and to help ensure coordinated movement across all of the elongate moveable longitudinal bars of the second grid 32.

FIG. 3d also shows the interleaving of the elongate moveable longitudinal bars of the second grid 32 between the elongate fixed longitudinal bars of the first grid 30.

FIG. 3d also shows the first grid 30 acting in the manner of a frame, to support an eccentric drive motor 51 at one end of the shaft housing 56 of the second grid 32, and a shaft cover plate 50 at the other end of the shaft housing 56. FIG. 3d also shows an eccentric drive plate 52 drivable by the drive motor 51 to move the shaft housing 56 to provide eccentric motion of the second grid 32 relative to the first grid 30. The drive shaft 52 can be driven by one or more other drivers, such as a hydraulic motor, or a belt drive from a separate power source.

FIGS. 3a and 3d also show the screening unit 22 having a flap 48 to provide smooth passage of feed material (to be processed) onto the screening unit 22 from the feeder hopper unit 3.

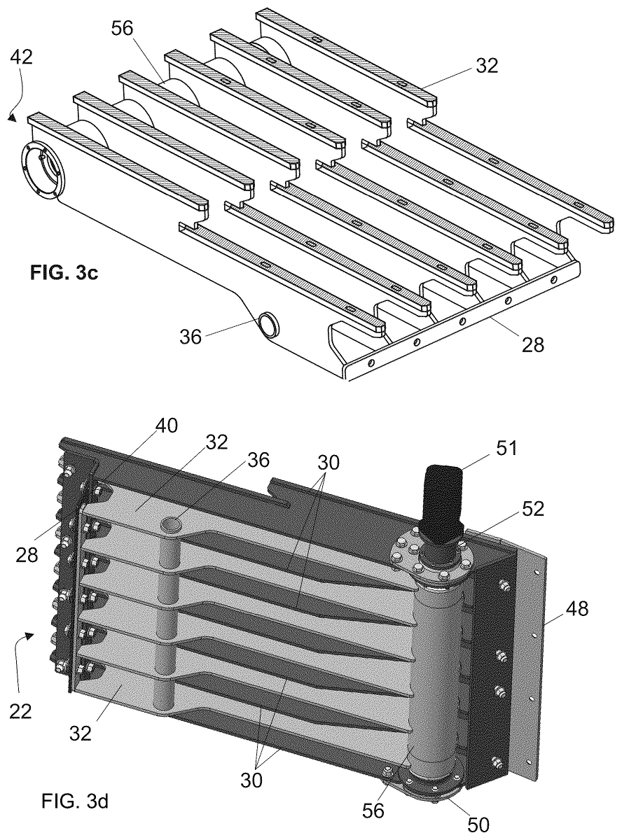

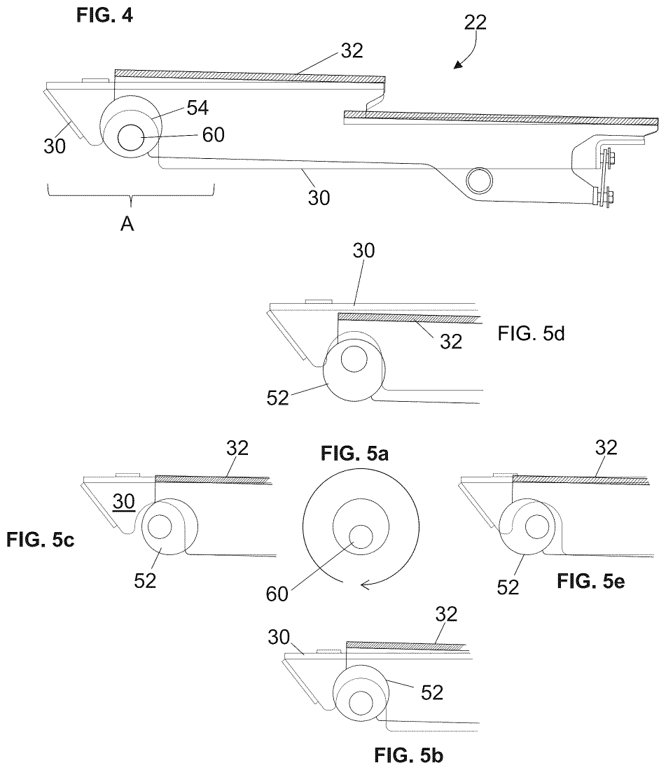

FIGS. 4 and 5a-5e are schematic side views of the screening unit 22, simplified for clarity purposes.

FIG. 4 shows the screening unit 22 in the manner of FIG. 3a, i.e. with the first grid 30 of elongate fixed longitudinal bars, and the second grid 32 on elongate moveable longitudinal bars interspaced with the fixed longitudinal bars of the first grid 30. FIG. 4 also shows, the cut-outs 54 of the first grid 30 for positioning the shaft housing of the second grid, and a centre of rotation 60 of the drive plate 52.

FIG. 5a shows a directional view of the drive plate 52 of FIG. 4, and FIGS. 5b-5e are four schematic views of portion A of FIG. 4 at different positions of the drive plate 52 during one rotation thereof.

Thus, FIG. 5b shows the drive plate 52 in a first position, such that the longitudinal bars of the second grid 32 are above the relatively ‘fixed’ longitudinal bars of the first grid 30. As the drive plate 52 rotates in the manner and direction of FIG. 5a, a second position of the second grid 32 relative to the first grid 30 is reached, as shown in FIG. 5c. The longitudinal bars of the second grid 32 are now in line with the longitudinal bars of the first grid 30.

In a similar manner, after the drive plate 52 further rotates in the manner and direction of FIG. 5a, a third position of the second grid 32 relative to the first grid 30 is reached, as shown in FIG. 5d. The longitudinal bars of the second grid 32 are now below with the longitudinal bars of the first grid 30. In a similar manner, after the drive plate 52 further rotates in the manner and direction of FIG. 5a, a fourth position of the second grid 32 relative to the first grid 30 is reached, as shown in FIG. 5e. The longitudinal bars of the second grid 32 are now below with the longitudinal bars of the first grid 30. Further rotation of the drive plate 52 returns the second grid 32 relative to the first grid to the first positions shown in FIG. 5b.

The skilled person can see that using other shapes of drive plates can lead to other eccentric motions between the first and second grids. Furthermore, the present invention is not limited by the position of the driving force, and the position of the provider of eccentric motion between the first and second grids. An eccentric drive plate or drive shaft could be provided at other positions to achieve an eccentric motion between the first and second grids.

In this way, the action of the eccentric drive plate 52 creates an eccentric motion of the second grid 32 relative to the first grid 30, (alongside the existing vibration of the screening unit 30 caused by the hopper unit motor 4). The combined but different motions between the bars of the first and second grid 30, 32 serves to maximise the prevention of clogging and pegging between the bars of the first and second grids 30,32. This positive eccentric driving force especially helps in relation to heavy-duty screens or screening, where the overall vibrating motions of the screening unit 22 can lead to material driving itself into a clogging position.

FIGS. 3a to 5e also show a screening unit suitable for an aggregate processing plant for screening aggregate material.

The skilled person can see that using other shapes of drive plates can lead to other eccentric motions between the first and second grids. Furthermore, the present invention is not limited by the position of the driving force, and the position of the provider of eccentric motion between the first and second grids. An eccentric drive plate or drive shaft could be provided at other positions to achieve an eccentric motion between the first and second grids.

The present invention provides an improved screening unit and method of keeping material being screened ‘moving along’ or across the screening area, and the eccentric driven motion of the second grid of bars relative to the first grid of bars actively forces the differential or out of phase or multi-mode motion thereinbetween, to maximise the prevention of clogging and pegging between the bars of the first and second grids. This positive driving force especially helps in relation to heavy-duty screens, which are typically being vibrated as well, to maximise the screening function of heavy materials, such as rubble and building wastes from demolition sites, etc., as mentioned above.

As may be recognized by those of ordinary skill in the art based on the teachings herein, numerous changes and modifications may be made to the above-described and other embodiments of the present disclosure without departing from the scope of the disclosure. The components of the crusher screening unit as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose. In addition, the crusher screening unit may include more or fewer components or features than the embodiments as described and illustrated herein. Accordingly, this detailed description of the currently-preferred embodiments is to be taken as illustrative, as opposed to limiting of the disclosure.

As may be recognized by those of ordinary skill in the art based on the teachings herein, numerous changes and modifications may be made to the above-described and other embodiments of the present disclosure without departing from the scope of the disclosure. The components of the crusher screening unit as disclosed in the specification, including the accompanying abstract and drawings, may be replaced by alternative component(s) or feature(s), such as those disclosed in another embodiment, which serve the same, equivalent or similar purpose as known by those skilled in the art to achieve the same, equivalent or similar results by such alternative component(s) or feature(s) to provide a similar function for the intended purpose. In addition, the crusher screening unit may include more or fewer components or features than the embodiments as described and illustrated herein. Accordingly, this detailed description of the currently-preferred embodiments is to be taken as illustrative, as opposed to limiting of the disclosure.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprise” (and any form of comprise, such as “comprises” and “comprising”), “have” (and any form of have, such as “has”, and “having”), “include” (and any form of include, such as “includes” and “including”), and “contain” (and any form of contain, such as “contains” and “containing”) are open-ended linking verbs. As a result, a method or unit that “comprises,” “has,” “includes,” or “contains” one or more steps or elements possesses those one or more steps or elements, but is not limited to possessing only those one or more steps or elements. Likewise, a step of a method or an element of a unit that “comprises,” “has,” “includes,” or “contains” one or more features possesses those one or more features, but is not limited to possessing only those one or more features. Furthermore, a unit or structure that is configured in a certain way is configured in at least that way, but may also be configured in ways that are not listed.

The disclosure has been described with reference to the preferred embodiments. It will be understood that the architectural and operational embodiments described herein are exemplary of a plurality of possible arrangements to provide the same general features, characteristics, and general system operation. Modifications and alterations will occur to others upon a reading and understanding of the preceding detailed description. It is intended that the disclosure be construed as including all such modifications and alterations.

1. A crusher screening unit for use between a crusher material feeder and a material crushing zone, the unit comprising a first grid of elongate fixed longitudinal bars, and a second grid of elongate moveable longitudinal bars interspaced with the fixed longitudinal bars,
wherein the second grid is directly driven in use in an eccentric motion relative to the first grid.

2. A crusher screening unit as claimed in claim 1, wherein the upper portions of the fixed longitudinal bars and the upper portions of the moveable longitudinal bars are wholly or substantial in the same in cross-section.

3. A crusher screening unit as claimed in claim 2, wherein the upper portions of the fixed longitudinal bars and the upper portions of the moveable longitudinal bars are T-shaped in cross-section.

4. A crusher screening unit as claimed in claim 1, wherein the upper portions of the fixed longitudinal bars and the upper portions of the moveable longitudinal bars are wholly or substantial Z or S shaped in a longitudinal direction.

5. A crusher screening unit as claimed in claim 1, wherein the fixed longitudinal bars and the upper portions of the moveable longitudinal bars form a multiple-tiered screening surface.

6. A crusher screening unit as claimed in claim 1 wherein the elongate moveable longitudinal bars are securely attached to the first grid via a flexible joint or transverse plate.

7. A crusher screening unit as claimed in claim 6, wherein the flexible joint of transverse plate is located below the fixed and moveable longitudinal bars.

8. A crusher screening unit as claimed in claim 6, wherein the transverse plate is fixed to a cross-plate supporting the fixed longitudinal bars, and fixed to a cross-plate supporting the moveable longitudinal bars.

9. A crusher screening unit as claimed in claim 1, wherein the moveable grid further comprises a supporting framework extending beneath the fixed and moveable longitudinal bars.

10. A crusher screening unit as claimed in claim 1, wherein the moveable grid further comprises a transverse cross-strut beneath the fixed and moveable longitudinal bars.

11. A crusher screening unit as claimed in claim 1, wherein the upper portions of the moveable longitudinal bars longitudinally taper.

12. A crusher screening unit as claimed in claim 1, wherein the second grid is driven by a drive motor.

13. A crusher screening unit as claimed in claim 12, wherein the second grid is driven by an eccentric shaft of the drive motor.

14. A crusher screening unit as claimed in claim 1, wherein the crusher material feeder is an integral feed hopper.

15. A crusher screening unit as claimed claim 1 further comprising a separate driver for vibrating the unit in use.

16. A crusher comprising a crusher screening unit, wherein the unit comprises a first grid of elongate fixed longitudinal bars, and a second grid of elongate moveable longitudinal bars interspaced with the fixed longitudinal bars,
wherein the second grid is directly driven in use in an eccentric motion relative to the first grid.

17. A crusher as claimed in claim 16, wherein the crusher is at least one of a jaw crusher or a roll crusher.

18. A crusher as claimed in claim 16, wherein the crusher is an impact crusher.

19. A screening unit for screening aggregate material, the unit comprising a first grid of elongate fixed longitudinal bars, and a second grid of elongate moveable longitudinal bars interspaced with the fixed longitudinal bars, wherein the second grid is directly driven in use in an eccentric motion relative to the first grid.

20. An aggregate processing plant for screening aggregate material comprising a mobile chassis having a main frame and a vibrating screening unit mounted via one or more absorbers on a screen-mounting frame, and able to provide at least one aggregate discharge stream therethrough, wherein the feed for the vibrating screening unit includes a screening unit as defined in claim 19.
